(19) United States
(12) Patent Application Publication
(10) Pub. No.: US 2026/0027724 A1
(43) Pub. Date: Jan. 29, 2026

(54) END EFFECTOR OF AUTOMATED VEHICLE CHARGING ROBOT FOR AUTOMATICALLY OPENING DOORS OF CHARGE PORTS OF ELECTRIC VEHICLES AND PLUGGING CHARGING CABLES

(71) Applicant: EMBOTECH AG, Zürich (CH)

(72) Inventors: David André MAUDERLI, Zürich (CH); Thivaharan ALBIN RAJASINGHAM, Zürich (CH); Elias Lukas HAMPP, Zürich (CH)

(73) Assignee: EMBOTECH AG, Zürich (CH)

(21) Appl. No.: 18/994,771

(22) PCT Filed: Jul. 15, 2022
(86) PCT No.: PCT/EP2022/069844

§ 371 Date: Jan. 15, 2025

(51) Int. Cl. B25J 9/16; B25J 13/08; B25J 15/04; B60L 53/16; B60L 53/37; E05F 15/73; E05F 15/75

(52) U.S. Cl. CPC B25J 9/1697; B25J 13/085; B25J 15/0441; B60L 53/16; B60L 53/37; E05F 15/75; E05F 2015/767; E05Y 2900/534

(57) ABSTRACT

The invention is notably directed to end effector (10, 10a) for an automated vehicle charging robot (1). The end effector (10, 10a) comprises: a connecting module (100), which is delimited by a reference plane (P) and is designed to enable a connection of the end effector (10, 10a) to a robotic arm (40) of the charging robot (1) on a first side of the reference plane (P); an electrical connector (106, 108) including a body (108) and a plug (106), the plug designed to connect to a charge port (220) and arranged at an end of the body (108), wherein the body (108) extends from the connecting module (100) to the plug (106) on a second side of the reference plane (P), the second side opposite to said first side, along an extension direction (De) that is transverse to the reference plane (P); and an actuator (114, 115) that protrudes from said body (108), transversely to said extension direction (De), the actuator (114, 115) designed to actuate a door (210) of the vehicle charge port (220). The invention is further directed to: a functionalized robotic arm (40), which includes such an end effector; an automated vehicle charging system (1), which includes such a robotic arm; and a method of electrically charging an electrical vehicle using such a functionalized robotic arm.

### BACKGROUND

The invention relates in general to end effectors for automated vehicle charging robots, as well as robotic arms that are functionalized thanks to such end effectors. The invention is further directed to related automated vehicle charging systems and methods of electrically charging electrical vehicles. In particular, it concerns an end effector that includes an actuator, which is arranged so as to allow the automatic opening of the door of the vehicle's charge port, by suitably rotating the end effector.

An electric vehicle (EV) is a vehicle that relies on one or more electric motors for propulsion. Of particular interest are road vehicles (i.e., electric cars) that can be powered autonomously by a battery. Such EVs are mostly designed as plug-in electric vehicles (PEVs, including all-electric vehicles and plug-in hybrid vehicles), i.e., road vehicles that utilize an external source of electricity (e.g., a wall socket that connects to the power grid) to store electrical power in its rechargeable battery packs.

Given the sparsity of charging stations for EVs, automated vehicle charging (AVC) is becoming increasingly popular; such systems increase the charging throughput per station. Existing AVC prototypes typically rely on vision-based plug pose estimates. Examples of such prototypes are described in “Autonomous Charging of Electric Vehicles in Industrial Environment”. Hirz, M., Walzel, B., & Brunner, H. (2021). Tehnički Glasnik, 15(2), 220-225. https://doi.org/10.31803/tg-20210428191147.

Designing a fully automated vehicle charging system is not an easy task, also because vehicles are typically equipped with charge port doors, which prevents the charging cable from being directly plugged in the charge port.

### SUMMARY

According to a first aspect, the present invention is embodied as an end effector for an automated vehicle charging robot. The end effector comprises a connecting module, an electrical connector, and an actuator for handling the charge port door. The connecting module is delimited by a reference plane; it is designed to enable a connection of the end effector to a robotic arm of the charging robot on a first side (i.e., the back side) of the reference plane. The electrical connector includes a body and a plug. The plug is designed to connect to a charge port of the vehicle and is arranged at an end of the body. The body of the electrical connector extends from the connecting module to the plug, on a second side of the reference plane (opposite to the first side), along an extension direction that is transverse to the reference plane. The actuator protrudes from the body of the electrical connector, transversely to said extension direction. The average direction of the actuator is preferably perpendicular to the extension direction of the body. The actuator is designed to permit actuation of a door of the vehicle charge port.

As defined above, the actuator is assumed to be a rigid and static element, which is solely actuated by the robotic arm, without requiring any active component to open the charge port door. That is, the end effector combines an electrical connector and a passive actuator, which is judiciously arranged with respect to the body of the electrical connector. Thanks to the proposed design, the end effector can be rotated by the robotic arm, so that the actuator can be set in position to safely actuate a charge port door of an electric vehicle, by pressing the door at a certain location. Accordingly, there is no need to provide a separate tool (another end effector or robotic arm) to open the vehicle charge port door. Thus, the proposed solution makes it possible to reduce the time duration of the overall plugging process, as well as the costs, given that a single tool is needed to both open the charge port door and plug the connector.

In preferred embodiments, the extension direction of the body of the electrical connector is inclined with respect to an axial direction that is perpendicular to the reference plane, it being noted that the connecting module is preferably designed to allow the end effector to axially connect to the robotic arm, along this axial direction. The inclination of the extension direction ensures, together with the transverse actuator, a collision safety margin that keeps all elements on the backside of the tool away from the car body. Accordingly, this allows the end effector (and thus the actuator) to be suitably rotated to open the charge port door without causing collisions. Having the actuator perpendicular to the extension direction of the body maximizes the collision safety margin.

The extension direction of the body may for instance form an angle with the axial direction, where this angle is between 25 degrees and 45 degrees, preferably between 30 degrees and 40 degrees, and more preferably between 34 degrees and 36 degrees.

In embodiments, the actuator is recessed with respect to the plug (along the extension direction of the body), so as to be closer to the connecting module than the plug. This further lowers the risk of collisions and allows the plug of the electrical connector to reach into the charge port of the vehicle, while avoiding collisions between the actuator and the vehicle body.

Preferably, the connecting module includes several submodules designed to cooperate with each other to enable the connection of the end effector to a robotic arm. In preferred embodiments, the submodules are designed to enable said connection as a controllably detachable connection. This way, a same robotic arm can successively pick up and plug several end effectors into respective charge ports. Alternatively, or in addition, the robotic arm can choose among different end effector plug formats, corresponding to distinct charge port standards.

In particular, the submodules may include two magnetic parts forming an electropermanent magnet, which enables said controllably detachable connection. This allows a simple, reliable, and accurate connection, making it easy to switch end effectors.

In embodiments, the submodules include a force-torque sensor, which is axially connected (or connectable) to another one of the submodules. Exploiting force feedback makes it possible to relax constraints in terms of accuracy needed to align and plug the electrical connector. The force-torque sensor is preferably designed to be fixedly mounted, axially, to the robotic arm, to allow the end effector to axially connect to the robotic arm via the force-torque sensor.

In embodiments where the submodules include two magnetic parts (forming an electropermanent magnet), one of the magnetic parts may be fixedly mounted to an end section of the body of the electrical connector, whereas the other magnetic part may be fixedly mounted, axially, to the force-torque sensor. This way, the end effector can be controllably attached to (and detached from) the robotic arm, axially.

In preferred embodiments, the end effector further includes a camera that is fixed to one of the submodules. Preferred is to attach the camera to the submodule that is the farthest from the plug, to enlarge the field of view of the camera. In addition, such a configuration lowers the risk for the camera to accidentally interfere with the force-torque measurements, due to potential inadvertent tension of the cable of the camera.

The camera may advantageously be asymmetrically arranged, i.e., on one side of the electrical connector. That is, the camera is preferably arranged on one side of the plane containing the extension direction and the projection thereof in the reference plane, such that neither the actuator nor the body of the electrical connector is in a field of view of the camera.

If necessary, the camera may further be rotated, to make sure that neither the actuator nor the body of the electrical connector is in a field of view of the camera. The camera has at least one sensor, which normally includes a lens. The optical axis of the lens is transverse to the reference plane. Now, this optical axis can advantageously be rotated, horizontally, by an offset angle. That is, the optical axis is rotated around a rotation axis that is parallel to the projection of the extension direction of the body in the reference plane. Now, this offset angle can be chosen so that neither the actuator nor the body of the electrical connector is in the field of view of the camera. The optimal offset angle depends on the dimensions of the various parts involved. Typically, the offset angle is between 10 degrees and 30 degrees, and preferably between 17 degrees and 23 degrees.

The camera may advantageously be a depth camera, which includes two or more sensors. The two or more sensors are vertically arranged. I.e., the sensors are arranged along an axis that is parallel to the rotation axis around which the camera is rotated. This way, the camera can be tilted (with respect to the above rotation axis). This makes it possible to avoid undesired inertial effects and also contributes to lower the risk for the camera to accidentally interfere with the force-torque measurements, should the camera be affixed to the force-torque sensor.

In embodiments, the actuator includes a protruding part and a pressure member. The protruding part extends from the body to the pressure member, while the pressure member is designed to come in contact with the charge port door and, e.g., gently actuate the latter without damaging it.

According to another aspect, the invention is embodied as a functionalized robotic arm for an automated vehicle charging robot. The functionalized robotic arm includes a robotic arm and an end effector as described above, wherein the connecting module of the end effector is connected or connectable to the robotic arm. I.e., the robotic arm is functionalized in accordance with the end effector. Preferably, the functionalized robotic arm further includes a light source, which is arranged to illuminate towards the second side of the reference plane.

According to a further aspect, the invention is embodied as an automated vehicle charging system. The system includes a functionalized robotic arm as described above. In addition, it includes a computerized system, which is operatively connected to the functionalized robotic arm and configured to instruct the robotic arm to actuate the end effector, so as to open a charge port door of a vehicle via the actuator of the end effector and plug (i.e., connect) the plug of the electrical connector into a charge port of the vehicle. The automated vehicle charging system may notably include one or more charging stations, to which one or more end effectors are electrically connected. The end effectors may possibly have different plug types. Plus, as noted earlier, each of the end effectors may advantageously be controllably attachable to and detachable from the robotic arm. This way, a same robotic arm may choose among different plug types and/or plug several end effectors to charge several vehicles.

According to a final aspect, the invention is embodied as a method of electrically charging an electrical vehicle using a functionalized robotic arm as described above. The method basically amounts to actuating the end effector, via the robotic arm, and according to distinct actuation sequences. Namely, the end effector is actuated according to a first actuation sequence to open a charge port door of a charge port of a vehicle via the actuator of the end effector. Next, the end effector is actuated according to a second actuation sequence to connect the plug of the electrical connector to the charge port of the vehicle.

Preferably, the method further comprises, prior to actuating the end effector according to the first actuation sequence, actuating the robotic arm according to an initial connection sequence, in order to controllably connect it to the end effector. Similarly, the method may further controllably disconnect the robotic arm from the end effector. This may notably be performed as the end effector is still connected to the charge port to charge the corresponding vehicle. Next, the method may actuate the robotic arm according to a further connection sequence, in order to controllably connect the robotic arm to another end effector, with a view to connecting (or disconnecting) the other end effector to (or from) the charge port of another vehicle. Once the respective vehicle is charged, each end effector may further be actuated according to a third actuation sequence, to retract the end effector and disconnect the plug from the charge port of a respective vehicle (possibly after having first reattached the robotic arm to the corresponding end effector).

### BRIEF DESCRIPTION OF THE DRAWINGS

These and other objects, features and advantages of the present invention will become apparent from the following detailed description of illustrative embodiments thereof, which is to be read in connection with the accompanying drawings. The illustrations aim at facilitating one skilled in the art in understanding the invention in conjunction with the detailed description. In the drawings:

FIG. 1 is a 3D view of an automated vehicle charging robot, which includes a robotic arm and an end effector, according to embodiments. The end effector is equipped with an electrical connector, which is designed to charge an electric vehicle;

FIG. 2 is a side view of an end effector, in which an actuator protrudes from the body of the electrical connector, according to embodiments. The actuator is designed to actuate a door of a vehicle charge port. The end effector further includes a connecting module, which allows the end effector to be connected to the robotic arm on the back side of the end effector;

FIG. 3 is a side view of a variant to the end effector of FIG. 2, in which the connecting module includes two magnetic parts forming an electropermanent magnet, as in embodiments. The latter makes it possible to easily attach and detach the end effector;

FIG. 4A is a 3D view of the end effector of FIG. 3. FIG. 4B is a similar 3D view, further illustrating how the end effector can be axially connected to the terminal link of a robotic arm;

FIG. 5 is an exploded view of the end effector of FIG. 3, showing relationship and order of assembly of submodules of the connecting module of the end effector, as in embodiments;

FIGS. 6A, 6B, and 6C, are views illustrating how the end effector can be actuated (i.e., rotated and moved), via the robotic arm, to first open the charge port door of a vehicle (FIG. 6A, top view), and then plug the electrical connector of the end effector into the charge port of the vehicle (FIG. 6B, side view; FIG. 6C, top view), as in embodiments;

FIG. 7 schematically represents the high-level architecture of an automated vehicle charging system, which includes a functionalized robotic arm and a computerized system, as in embodiments; and

FIG. 8 is a flowchart illustrating high-level steps of a method of operating a functionalized robotic arm to charge electrical vehicles, according to embodiments of the invention.

The accompanying drawings show simplified representations of devices or parts thereof, as involved in embodiments. Technical features depicted in the drawings are not necessarily to scale. Similar or functionally similar elements in the figures have been allocated the same numeral references, unless otherwise indicated.

Devices, apparatuses, systems, and methods, embodying the present invention will now be described, by way of non-limiting examples.

### DETAILED DESCRIPTION OF EMBODIMENTS OF THE INVENTION

Ideally, an automated vehicle charging system should be both reliable and efficient, in terms of time required to plug and unplug the charging cable. While cable plugging is the primary task to solve, there may be obstructions that prevent the cable from being directly plugged in. Due to safety reasons, most, if not all, charging inlets (i.e., charge ports) are covered by a door that has to be opened prior to connecting the cable. While some high end car models come with electric actuators that automate this task, for most car models this has to be done manually. Thus, the inventors challenged themselves to develop a system capable of both opening the charge port door and plugging the electric cable.

They have notably considered the following approaches. A first possibility is to equip the system with two separate robotic arms, having respective end effectors, one including an electrical connector, the other designed to actuate the door, e.g., by way of a vacuum gripper. Such an approach, however, is costly and difficult, be it in terms of ergonomics. A less expensive variant would be to rely on a single robotic arm, capable of switching end effectors as defined above. This, however, requires switching end effectors to be able to charge a same vehicle, which can be quite inefficient. A further variant would be to rely on a single end effector (and a single robotic arm), where the end effector is equipped with an active component to open the door. Such an approach, however, is complex and costly.

With this in mind, the present inventors set the challenge to devise a more efficient system, which relies on a single end effector (and a single robotic arm), where the end effector involves static components designed to both open (and possibly close) the door of a charge port of an electric vehicle and then plug the electrical connector into the charge port. Such an approach, however, raises questions in terms of ergonomics, motion complexity, and costs. How should the end effector be designed to allow both tasks to be affordably performed, while preventing inadvertent collisions with the vehicle body? Facing this challenge, the present inventors came up with a simple solution, in which the electrical connector of the end effector includes an actuator that protrudes from the body of the electrical connector, transversely to the extension direction of the connector body.

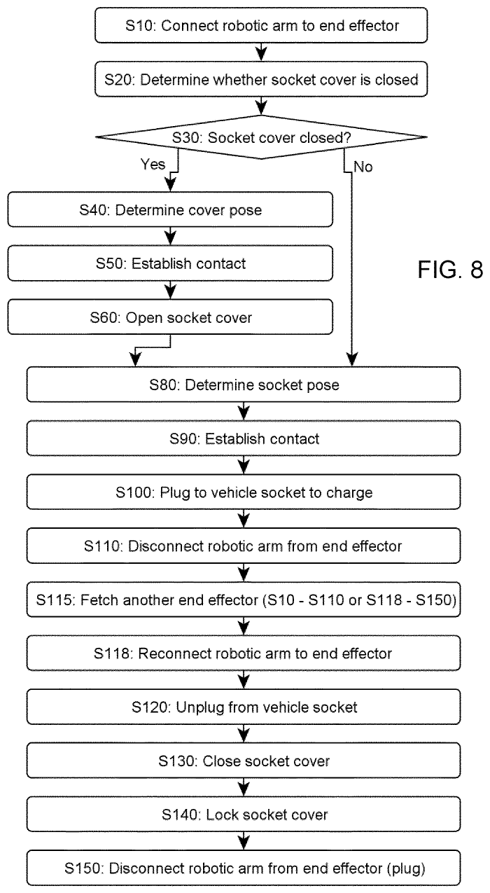

This is discussed in detail in the following description, which is structured as follows. General embodiments and high-level variants are described in section 1, while section 2 addresses particularly preferred embodiments and technical implementation details. Note, the present method and its variants are collectively referred to as the “present methods”. All references Sn refer to methods steps of the flowchart of FIG. 8, while numeral references and capital letters pertain to devices, components, and concepts, involved in embodiments of the present invention.

### 1. General Embodiments and High-Level Variants

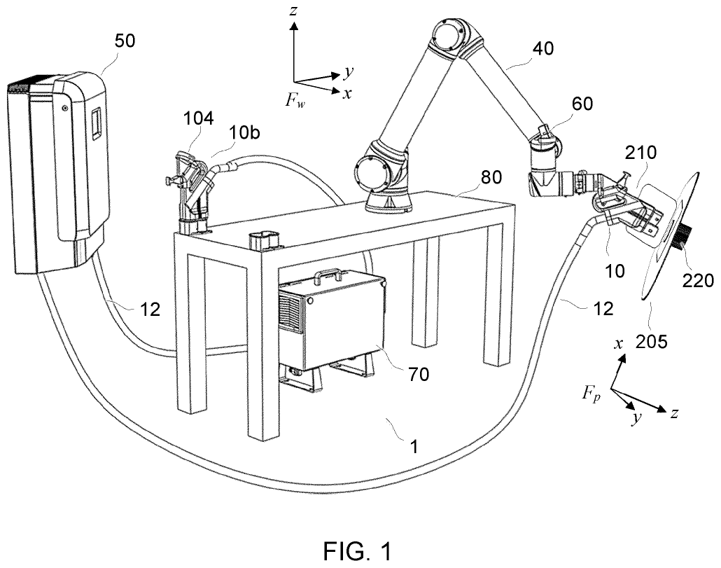

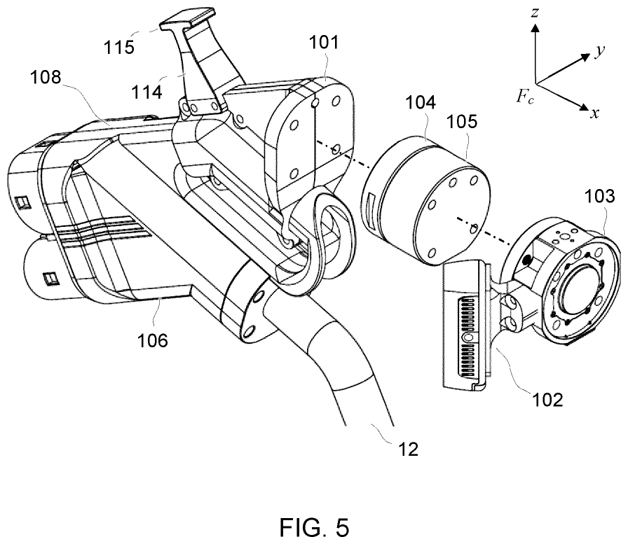

In reference to FIGS. 1-6C, a first aspect of the invention is now described in detail. This aspect concerns an end effector 10, 10a for an automated vehicle charging robot 1. The end effector 10, 10a basically comprises a connecting module 100, an electrical connector 106, 108, and an actuator 114, 115.

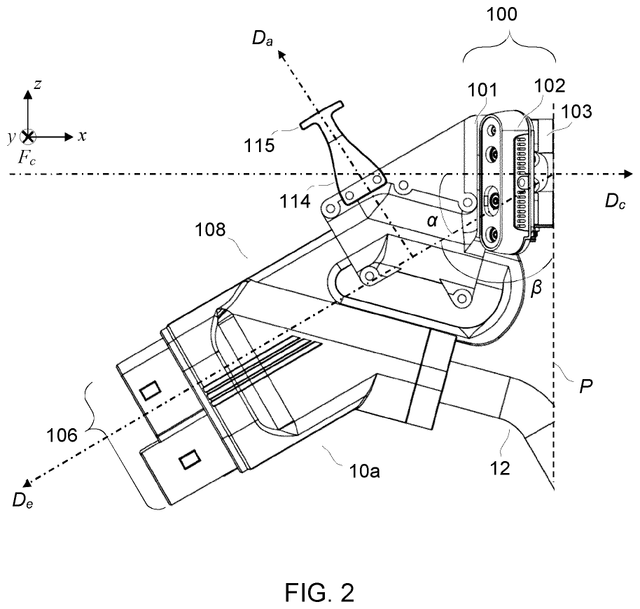

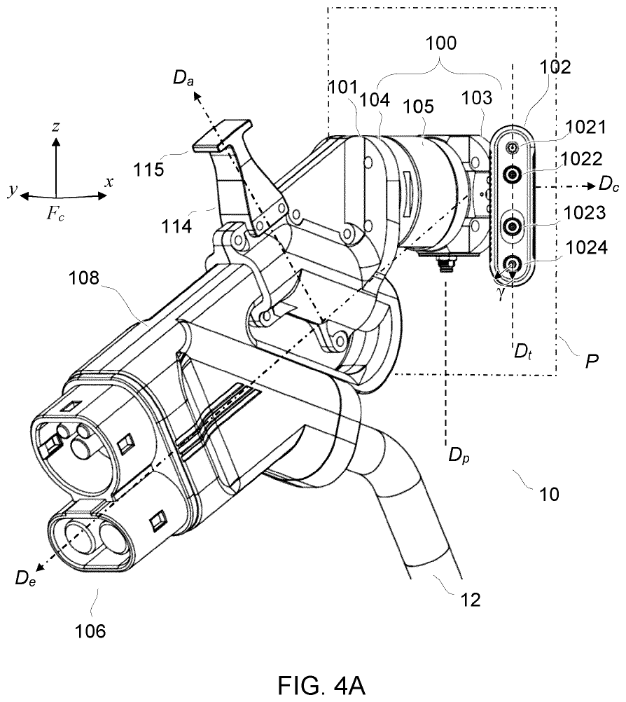

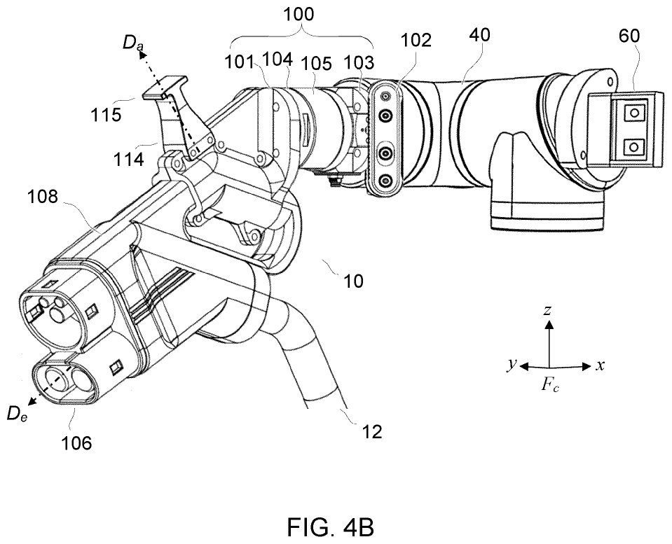

The connecting module 100 is generally designed to enable a connection of the end effector 10, 10a to a robotic arm 40 of the charging robot 1. In practice, the end effector is connected to a terminal link of the robotic arm, as illustrated in FIG. 4B. As shown in FIGS. 2, 3, and 4A, the connecting module 100 is delimited by a reference plane P. In the accompanying drawings, the reference plane P corresponds to the back plane of the module 100. This plane P delimits two opposite sides. The end effector 10, 10a is meant to connect to the robotic arm 40 on one side (hereafter the “first side”) and to the charge port 220 of the vehicle on the opposite side (the “second side”). The connection to the robotic arm is made on the first side of the reference plane P, which corresponds to the back side of the end effector 10, 10a. This connection is essentially a mechanical connection, even if it may involve electromagnetic connection means, as in embodiments discussed later. If necessary, the end effector may further be electrically connected to the robotic arm. Preferably, however, the electrical connector is directly connected to a charging cable 12, itself connected to a charging station 50, as illustrated in FIG. 1. The charging cable may thus be fully independent from the robotic arm.

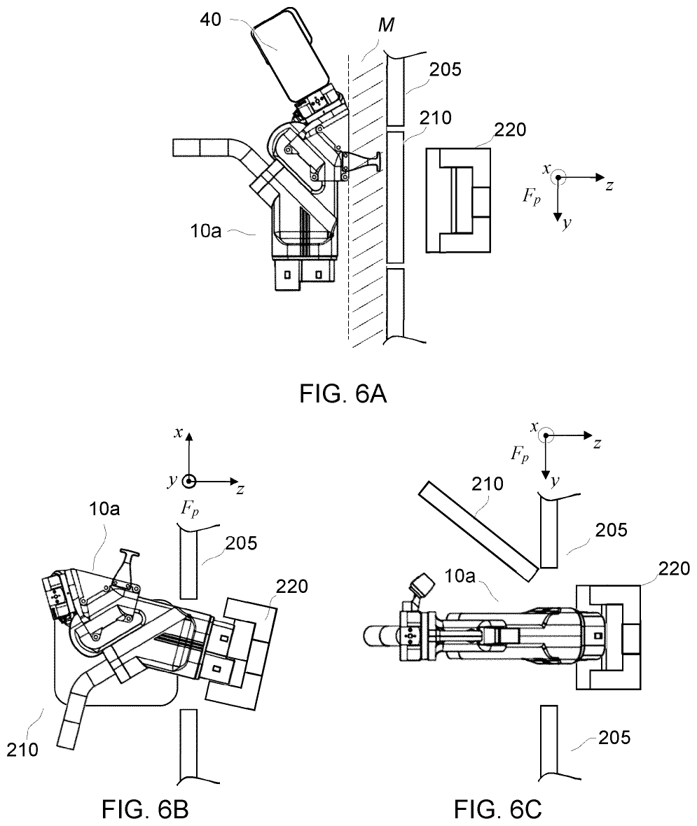

The electrical connector 106, 108 of the end effector includes a body 108 and a plug 106. The plug 106 is designed to connect (i.e., plug) into a charge port 220 of a vehicle, see FIGS. 6A-6C. That is, the plug 106 and the port 220 form mating parts, like a plug and a socket. The plug 106 is arranged at an end of the body 108. This end corresponds to the free end of the connector in practice, i.e., when the end effector is mounted to the robotic arm. The body 108 extends from the connecting module 100 to the plug 106 on the second side of the reference plane P, along an extension direction Dₑ that is transverse to the reference plane P.

The actuator 114, 115 is a piece, part, or member, that protrudes from the body 108 of the electrical connector 106, 108, transversely to the extension direction Dₑ. That is, the actuator 114, 115 protrudes transversely from the average direction of the connector body 108. It preferably extends orthogonally to the average direction of the body 108 and, thus, orthogonally to the extension direction Dₑ. This actuator 114, 115 is generally designed to actuate a door 210 of the charge port 220 of the vehicle, as illustrated in FIG. 6A. It may for instance include a pressure member 115 on top of a protruding part 114, as assumed in the accompanying drawings. That is, the protruding part 114 extends from the body 108 to the pressure member 115. The latter is designed to come into safe contact with the charge port door 210. Note, the pressure member is preferably coated by a soft material, such as foam, to avoid scratching or otherwise damaging the charge port door.

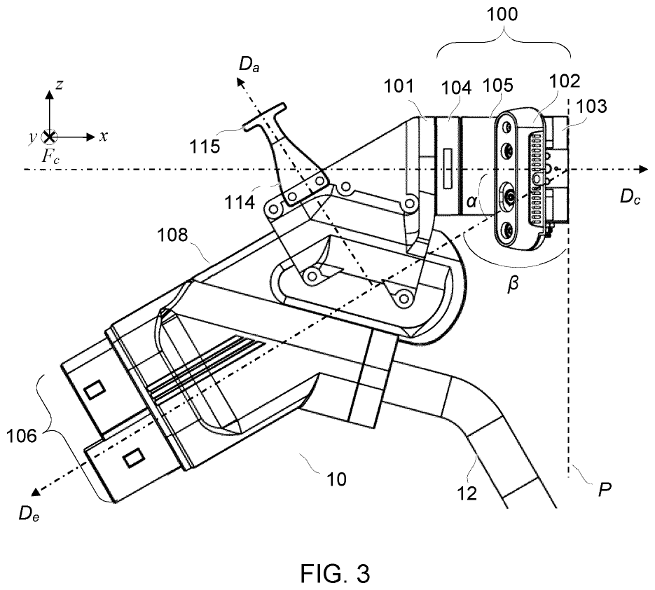

Comments are in order. The connecting module 100 forms a mechanical interface, which enables a connection of the end effector 10, 10a to the robotic arm 40 on the first side of the delimiting plane P. The mechanical interface may possibly be designed to allow a direct or an indirect mechanical connection, e.g., via intermediate submodules 104, 105, as discussed later in reference to FIGS. 3-5. The connecting module 100 may for instance allow an axial connection to the terminal link of the robotic arm 40 (see FIG. 4B), perpendicularly to the reference plane P.

The body 108 of the electrical connector typically is a casing, which houses a terminal portion of a charging cable 12. This casing extends all along the extension direction Dₑ. The connector body 108 typically has a form factor; it typically has an elongated form, the average direction of which is parallel to the extension direction Dₑ. The body 108 may have several sections of different sizes, where one of the sections includes the plug 106, while another section supports the actuator 114, 115, as assumed in the accompanying drawings. The actuator may for instance be mechanically affixed to the body 108 using conventional fasteners such as bolted joints, clamping a base of the member 114 onto a respective section of the body 108. For example, each bolted joint may include a male threaded part inserted in a matching female threaded part. In variants, other types of fasteners can be used, such as blind bolts or screws.

The average direction Dₐ of the actuator 114, 115 is preferably perpendicular to the extension direction Dₑ of the body 108. That is, the actuator 114, 115 may generally extend perpendicularly to the average direction of the connector body 108. In variants, some tolerance can be accepted (e.g., +10 or 20°), such that the angle formed between the actuator direction Dₐ and the average direction of the connector body Dₑ may typically be between 70° and 110°.

The connector body 108 extends transversely to the reference plane P, on the second side thereof. However, it is not necessarily orthogonal to the reference plane P (“transversely” does not necessarily mean “perpendicular”, i.e., at right angle to the reference plane). In fact, the average direction of the body 108 is much preferably inclined with respect to the connection axis D_{c}, so as to form an angle with respect to the plane P, for reasons explained below.

The actuator is a rigid and static element, which is solely actuated by the robotic arm, without requiring any active component (such as electric drives, pneumatic or hydraulic elements, magnetic actuators) to open the charge port door. That is, the end effector combines an electrical connector and a passive actuator, which is judiciously arranged with respect to the body of the electrical connector. Thanks to the proposed design, the end effector can be rotated by the robotic arm 40, so that the actuator 114, 115 can be set in position to safely actuate a charge port door 210, by pressing the door 210 at a certain location, as depicted in FIG. 6A. Accordingly, there is no need to provide a separate tool (another end effector or robot) to open the vehicle charge port door 210. Thus, the proposed solution makes it possible to reduce the time duration of the plugging process. This further reduces the overall costs, given that a single tool is needed to both open the charge port door and plug the connector. The present invention can find applications to charging robot systems for various types of electric vehicles, such as plug-in electric cars (also called electrically chargeable vehicles), electric motorcycles and scooters, city cars, neighbourhood electric vehicles (microcars), vans, buses, electric trucks, and military vehicles.

As evoked above, the extension direction Dₑ of the body 108 is preferably inclined with respect to an axial direction D_{c} that is perpendicular to the reference plane P. Typically, the axial direction D_{c} is the direction along which the end effector 10, 10a is mounted to the terminal link of the robotic arm 40. I.e., the connecting module 100 is preferably designed to allow the end effector 10, 10a to axially connect to the robotic arm 40, along said axial direction D. In practice, the inclination of the extension direction Dₑ ensures, together with the actuator 114, 115 that protrudes from the body 108, a collision safety margin M (see FIG. 6A) that keeps all elements on the backside 101 of the tool (e.g., connection elements 104, 105, a force-torque sensor 103, and the robotic arm 40) away from the car body 205, 210. This allows the end effector (and thus the actuator 114, 115) to be suitably rotated to open the charge port door 210 without causing collisions, as illustrated in FIG. 6A.

Note, the risk of collisions can further be lowered by recessing the actuator, away from the plug 106, as in embodiments described below. In addition, the proposed inclination makes it possible to avoid collisions between the robot arm and the car body during the plugging process, at least in certain cases. Still, the main reason for inclining the body 108 is that this avoids collisions between the robot and the car body during the door opening. I.e., inclining the direction Dₑ with respect to the direction D_{c} makes it possible to create a larger safety margin between the car body and the robot.

Thus, the extension direction Dₑ of the body 108 preferably forms an angle α with the axial direction D_{c}, as seen in FIGS. 2 and 3. This angle is typically between 25 and 45 degrees, preferably between 30 and 40 degrees, and more preferably between 34 degrees and 36 degrees. Accordingly, the connector body 108 is tilted with respect to the reference plane P, by an angle β that is between 45 degrees and 65 degrees, preferably between 50 degrees and 60 degrees, and more preferably between 54 and 56 degrees. The angle β is ideally equal to 55 degrees, as assumed in the accompanying drawings.

Note, several coordinate systems (also referred to as frames, typically Cartesian coordinate systems) are used in the accompanying drawings. The frame Fₚ (see FIGS. 1, 6A-6C) refers to the coordinate system of the charge port 220; the z-axis is parallel to the normal to the plane of the car body and points away from the effector as the latter is positioned to plug into the charge port, see FIG. 1. The world coordinate system is denoted by F_{w}; its z-axis points upward, see FIG. 1. The frame F_{c} refers to the natural coordinate system of the connecting module 100, see FIGS. 2-5. The plane (y, z) of the connecting module frame F_{c} is parallel to the reference plane P, while the x-axis of the connecting module frame F_{c} is parallel to the axial direction of the connecting module, along which the end effector preferably connects to the robotic arm 40. The direction Dₑ extends in the plane (x, z) of the connecting module frame F_{c} and forms an angle α with the axis x of F_{c} (for reasons explained above), while the direction D_{c} is parallel to this axis x. Similarly, the direction Dₐ extends in (x, z) and forms an angle equal to α+900 with respect to the axis x of F_{c}. Finally, each of the additional directions Dₚ and D shown in the drawings are parallel to the axis z of F.

As evoked earlier, the actuator 114, 115 is preferably recessed with respect to the plug 106 along the extension direction Dₑ, so as to be closer to the connecting module 100 than to the plug 106. This allows the end plug 106 of the electrical connector 106, 108 to reach into the charge port 220 of the vehicle, while avoiding collisions of the actuator 114, 115 with the vehicle body 205. Moreover, this makes it possible to lower the risk of collision between the actuator 114, 115 and the vehicle charge port door 210, upon actuating (i.e., moving and rotating) the end effector 10, 10a.

In simple implementations, the connecting module may restrict to a single component, e.g., forming a rear panel 101. The module may be integral with the body 108. In such embodiments, the rear panel 101 is structured so as to allow connection with the robotic arm 40. However, in variants as illustrated in FIGS. 2-5, the connecting module 100 preferably includes several submodules 101-103 (FIG. 2) or 101-105 (FIGS. 3-5), which are designed to cooperate with each other to enable said connection.

In embodiments of the end effector 10 as shown in FIGS. 3-5, the submodules 101-105 are designed to enable a controllably attachable and detachable connection to/from the robotic arm 40. That is, the end effector 10 can be controllably attached to and detached from the robotic arm 40, thanks to the submodules, such that a same robotic arm can successively pick up and plug several end effectors into respective charge ports. The submodules may, in general, involve mechanical, electromagnetic, and/or pneumatic means.

A preferred approach, however, is to rely on an electropermanent magnet. In that case, the submodules include two magnetic parts 104, 105, which form the electropermanent magnet, as assumed in FIGS. 3-5. The two magnetic parts 104, 105 can notably be formed as two complementarily shapes (e.g., flanges), one of high-coercivity magnetic material and one of low-coercivity material. The external magnetic field is switched on or off by a pulse of electric current in a wire winding around one of the magnets. I.e., applying power makes it possible to demagnetize the parts and detach the flanges, in a controllable fashion. In addition, complementary mating features can be provided on each of the two magnetic parts to ensure a precise mechanical connection of the two magnetic parts. In variants, any suitable clutch mechanism can be used, e.g., relying on mechanical devices and/or pneumatic equipment. However, an electropermanent magnet allows a simpler and yet accurate connection, making it easier to switch end effectors.

The accompanying drawings show two types of end effectors 10, 10a. The end effector 10 shown in FIGS. 3-5 involve magnetic parts 104, 105 (which form an electropermanent magnet), at variance with the end effector 10a seen in FIGS. 2.

In both cases, the end effector 10, 10a can be axially fixed to the robotic arm 40 via a force-torque sensor 103. I.e., the force-torque sensor 103 is designed to be fixedly mounted, axially, to the robotic arm 40, to allow the end effector 10, 10a to axially connect to the robotic arm 40 via the force-torque sensor 103. That is, the connecting module 100 can be regarded as including at least two parts 101, 103, which are the rear panel 101 of the body 108 and the force-torque sensor 103, where the latter is meant to be axially fixed (i.e., fixedly mounted, axially) to the terminal link of the robotic arm 40. In other words, the force-torque sensor 103 is axially connectable, on the one hand, to the robotic arm and, on the other hand, to another one of the submodules 101, 104, 105. In the example of FIG. 2, the force-torque sensor 103 is directly fixed, axially, to the rear panel 101 of the end effector 10a. Once fixed to the rear panel 101, the force-torque sensor 103 can be considered to form part of the connecting module 100. In variants, the end effector is designed so as for the force-torque sensor to be integral with the body 108.

In the example of FIGS. 3-5, the force-torque sensor 103 is axially fixed to the magnetic part 105. The latter is meant to magnetically attach to the part 104, itself fixed to the rear panel 101. That is, the part 104 is fixedly mounted to the end section (i.e., the rear panel) 101 of the body 108 of the electrical connector, whereas the other part 105 is fixedly mounted, axially, to the force-torque sensor 103. This allows the end effector 10 to be controllably attached to and detached from the robotic arm 40.

Forces applied from the backside of the force-torque sensor 103 will not have an impact on the force-torque measurements. Conversely, forces applied from the frontside notably via the elements 106, 108, (104, 105), and 101, will influence the force-torque measurements. In variants, the body 108 of the electrical connector 106, 108 can be directly connected to the robotic arm 40. However, providing a force-torque sensor 103 is advantageous, inasmuch as it allows alignment constraints to be somewhat relaxed. That is, for cable plugging, a compliance control can be used, which exploits force feedback to compensate for estimation uncertainties and limit the contact reaction forces that are due to the rather high stiffness of the materials involved. Accordingly, the system can actively react to alignment errors upon cable plugging, such that constraints in terms of accuracy needed to align the electrical connector can be relaxed. In particular, exploiting feedback signals from the force-torque sensor 103 circumvents the need for sub-millimetre accuracy in the placement of the connector.

Typically, the algorithm used to align the connector 106, 108 primarily relies on computer vision. To that aim, a camera 102 is needed, which may advantageously be fixed to the force-torque sensor 103, as illustrated in FIGS. 2-5. Given that the force-torque sensor 103 is the last of the submodules, i.e., the farthest from the plug 106, the camera 102 is maximally recessed from the end plug 106. This results in maximizing the field of view (or field of vision) of the camera 102. In addition, because the camera is mounted to the base of the force-torque sensor, forces and torques that may result from inadvertent tension of the camera cable (e.g., a USB cable connected to the camera) do not measurably impact the force-torque sensor measurements. Consequently, less disturbance forces and torques are acting on the end effector. This improves the quality of the force-torque measurements and simplifies the force feedback-controlled mating process.

The camera 102 is preferably arranged asymmetrically with respect to connector body 108. That is, the camera is preferably located on one side (either side) of the plane spanned by the directions Dₐ and Dₑ, such that neither the camera 102 nor its cable comes to collide with the safety margin M resulting from the inclination of the body 108 and the protruding actuator 114, 115. That is, the camera is preferably placed on the left or right side of the end effector, so as not to interfere with the safety margin. This is particularly true where the end effector 10a is free of intermediate connection elements, as in the embodiment shown in FIG. 2. For an end effector 10 as shown in FIG. 3, which includes intermediate connecting elements 104, 105, the camera 102 may also be placed on top, without jeopardizing the safety margin. Placing the camera on top may actually simplify the motion execution, given that less motion is required to obtain images in that case.

The asymmetric placement of the camera also help achieve a configuration, in which neither the actuator 114, 115 nor the body 108 of the electrical connector 106, 108 is in the field of view of the camera 102. Various additional design options can be contemplated to make sure to free the field of view of the camera. For example, the camera 102 can be offset, i.e., attached to the sensor 103 via an arm that is long enough for the camera 102 to be sufficiently offset from the connector 106, 108. Such a solution can, however, cause the camera to impair the rotational movements of the end effector and also result in undesired inertial effects. Thus, a simpler solution is to tilt the camera 102 with respect to a vertical axis.

In more detail, the camera 102 includes at least one sensor, itself including a lens, the optical axis of which is transverse to the reference plane P. Now, this optical axis can be slightly rotated around the rotation axis Dₜ, which is parallel to the projection Dₚ of the extension direction Dₑ. This is best seen in FIG. 4A, where the camera 102 is tilted by an offset angle γ. This offset angle can be chosen so that neither the actuator 114, 115 nor the body 108 of the electrical connector 106, 108 is in the field of view of the camera 102. Yet, it should remain as small as possible, so as for the camera to correctly capture the scene of interest. The optimal offset angle depends on the dimensions of the various components involved. In practice, this angle will typically be between 10 degrees and 30 degrees. It preferably is between 17 degrees and 23 degrees when adopting an end effector design as shown in FIGS. 2-5, although the camera may also be placed on top, should intermediate connecting parts be used, as in FIGS. 3-5. For an end effector design as shown in FIG. 2, it is optimal to tilt the camera by 20 degrees.

The camera 102 may advantageously be a depth camera 102. Depth cameras are known per se. For example, use can be made of a stereo depth camera, having two sensors 1022, 1024 (see FIG. 4A), spaced a small distance apart, which are used to independently acquire distinct images. Given the known distance between the two sensors, comparing the two images allows depth information to be extracted. That is, the difference in the perspectives can be used to generate a depth map by calculating a numeric value for the distance from the imagers to every point in the scene. The camera may further include an infrared (IR) projector (or IR beamer 1023), to illuminate the scene with IR light and accordingly collect depth data. In that case, the stereo vision implementation relies on two IR imagers 1022, 1024 and the IR projector. The IR beamer 1023 projects a static IR pattern (invisible to the human eye), which is used to improve depth accuracy in scenes with low texture, as is the case with car bodies. The two imagers capture the scene and forward imager data to a depth imaging (vision) processor, which calculates depth values for each pixel in the image by correlating points on the two images, i.e., by exploiting the shift between corresponding IR points on the two images. That is, the depth pixel values are processed to generate a depth image.

As shown in the accompanying drawings, the camera is preferably arranged vertically, such that the two sensors are arranged along an axis that is parallel to the rotation axis Dₜ. Still, the optical axes of the two sensors are slightly rotated around the rotation axis Dₜ, as a result of the fact that the camera 102 is tilted by an offset angle γ.

Another aspect of the invention is now described in reference to FIGS. 1, 4B, and 6A. This aspect concerns a functionalized robotic arm for an automated vehicle charging robot 1. The functionalized robotic arm includes a robotic arm 40 and is functionalized thanks to an end effector 10, 10a as described above. The connecting module 100 of the end effector 10, 10a is connected to the robotic arm 40. The functionalized arm may possibly be supplied as a kit of parts, in which case the end effector is separately supplied (i.e., unassembled with the robotic arm yet). Still, the connecting module 100 of the end effector 10, 10a is designed so as to be connectable to the robotic arm 40 and can thus be connected thereto by a user.

Charging ports of electric vehicles usually show little contrast (they are typically black), which complicates vision-based estimations of the charge port pose (step S80), especially in poorly illuminated environments such as parking garages. To increase robustness against varying illumination conditions, the functionalized robotic arm may advantageously include a light source 60, see FIGS. 1 and 4B. The light source 60 is arranged to illuminate towards the second side of the reference plane P, i.e., to illuminate the charge port while estimating the charge port pose at step S80. The light source typically includes one or more LEDs, which are preferably arranged on the last link of the robotic arm. The light source can be oriented in essentially the same direction as the camera or in a direction that is intermediate between the direction of the electrical connector 106, 108 and the camera 102.

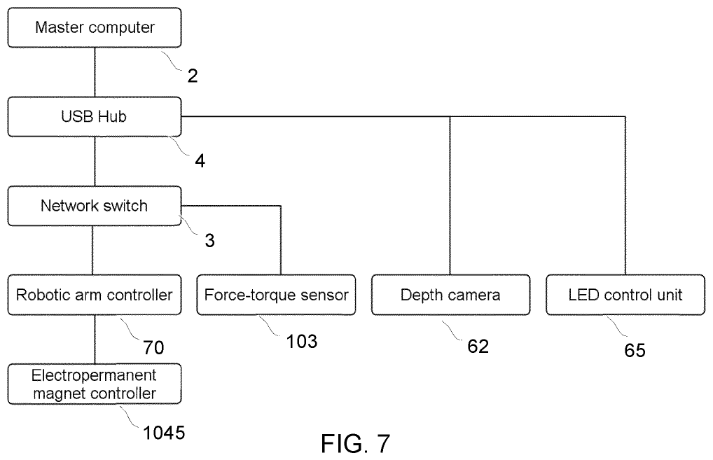

A further aspect of the invention concerns an automated vehicle charging system 1, as now discussed in reference to FIGS. 1 and 7. The system 1 includes a functionalized robotic arm 10, 40 as described above, as well as a computerized system 2. The computerized system 2 is operatively connected to the functionalized robotic arm 10, 40. It is configured to instruct the robotic arm 40 to actuate (i.e., rotate and possibly translate) the end effector 10, so as to open a charge port door 210 of a vehicle via the actuator 114, 115 of the end effector 10 and connect (i.e., plug) the plug 106 of the electrical connector 106, 108 of the end effector 10 into a charge port 220 of the vehicle, as discussed earlier.

Several end effector designs 10, 10a can be contemplated, as illustrated in FIGS. 2-5. The end effector may advantageously be designed to be controllably attachable to and detachable from the robotic arm 40, as described earlier. The automated vehicle charging system 1 may, in embodiments, further include a charging station 50 (e.g., in a wallbox configuration), to which several end effectors 10, 10b are electrically connected, as illustrated in FIG. 1. Since each of the end effectors 10 is controllably attachable to and detachable from the robotic arm 40, the same robotic arm 40 can be used to connect several end effectors (and thus several charging cables) to several vehicles, as described below in reference to a final aspect of the invention. In variants, the plugs 106 of the available end effectors may conform to different plug standards (e.g., type 1—J1772, GB/T, Type 2, CCS—Type 2, etc.), such that the robotic arm may pick the appropriate end effector in accordance with the car type.

A final aspect of the invention is now discussed in reference to FIG. 8. This aspect concerns a method of electrically charging an electrical vehicle. The method relies on a functionalized robotic arm 10, 40 as discussed above. The method is automatically performed, e.g., using a computerized system 2 as described above.

The method basically revolves around actuating the end effector according to different actuation sequences to open a charge port door and plug the electrical connector. In detail, the end effector 10, 10a is actuated (step S50) via the robotic arm 40 according to a first actuation sequence, with a view to opening S60 the charge port door 210 of the charge port 220 of the vehicle via the actuator 114, 115 of the end effector 10, 10a. Next, the end effector 10, 10a is actuated S90 (via the robotic arm 40) according to a second actuation sequence, to connect S100 the plug 106 of the electrical connector 106, 108 to the charge port 220.

Preferably, the method further determines whether the charge port door 210 is open, prior to actuating the end effector 10 according to the first actuation sequence. This can be achieved using computer vision methods, which are known per se. Use can for instance be made of the camera 102. E.g., a supervised model can be trained to classify images taken by the camera as corresponding to open or closed configurations. If the charge port door 210 is determined to be closed, then the end effector 10, 10a is actuated (step S50) to open S60 the charge port door 210, by suitably rotating the end effector for its actuator to press the door. Else, the end effector 10 is actuated so as to directly connect the plug 106 to the charge port 220.

Once the charge is complete, the end effector 10 may eventually be automatically actuated according to a third actuation sequence S150, to retract the end effector 10 and disconnect its plug 106 from the charge port 220.

Using detachable end effectors allows more sophisticated motions to be performed, with a view to automatically select suitable connector formats and/or charge several vehicles, using a same robotic arm. In that case, the robotic arm 40 may initially be actuated S10 (i.e., according to an initial connection sequence), in order to controllably connect it to a given end effector 10, prior to actuating S50 the end effector 10 according to the first actuation sequence. In the example of FIG. 1, the robotic arm 40 is assumed to have already picked up the end effector 10, leaving the other end effector 10b in place at the workstation 80.

Once the robotic arm 40 has picked up a suitable end effector 10, it may open a charge port door (if necessary) of a vehicle and connect the plug 106 of the end effector to the charge port of the vehicle, as described above. Having done so, the robotic arm may then possibly disconnect S110 from the end effector 10 (as the latter is still connected to the charge port 220 to charge the vehicle), with a view to picking up another end effector 10b and charging another vehicle. Alternatively, the robotic arm 40 may pick up another end effector (not shown) that is already plugged in another vehicle (e.g., the charge of which is complete), with a view to disconnecting this other end effector from the other vehicle and bringing it back to the workstation 80. To summarize, the robotic arm 40 may possibly be actuated according to a further connection sequence, in order to controllably connect S10, S118 the robotic arm to another end effector 10b, with a view to connecting (or disconnecting) this other end effector to (or from) the charge port 220 of another vehicle.

The base of the robotic arm 40 may possibly be static (as assumed in FIG. 1), given that a same robotic arm may be rotated to reach 2 to 4 vehicles parked around it. In variants, the robotic arm 40 may possibly be translated (or otherwise moved) so as to adequately reach several vehicle charge ports. To that aim, various transportation means can be used. The robotic arm may for instance be mounted on an autonomous vehicle or be guided along a running surface, e.g., a magnetic track, or be suspended from one or more cables, for example, so as to successively reach several parked vehicles.

The above embodiments have been succinctly described in reference to the accompanying drawings and may accommodate a number of variants. Several combinations of the above features may be contemplated. Examples are given in the next section.

### 2. Specific Embodiments

### 2.1 Preferred Components

Robotic arms. Various types of robotic arms can be contemplated, as long as such arms are capable of handling payloads on the order of 1.5 to 3.0 kilograms, i.e., corresponding to the typical mass of the present end effectors (taking into account the mass of the cable that is effectively supported by the arm, in operation). The rear panel 101 of the connecting module 100 can be adapted to match any type of terminal link of the robotic arm. In general, suitable robotic arms will include several links, connected by joints allowing rotational motions and possibly translational (linear) displacement, where the links form a kinematic chain. The robotic arms are normally programmable and supplied with adequate computing means. Use can for instance be made of an industrial manipulator from Universal Robots, such as the UR10e robot.

Cameras. Various types of cameras can be contemplated too. Use if preferably made of a stereo depth camera, relying on IR projection, such as an Intel Realsense D435i or D435 depth camera. Such cameras have a form factor; they can be vertically arranged and tilted, as discussed in section 1, whereby the camera sensors (i.e., RGB sensor 1021, IR sensors 1022 and 1024, and IR beamer 1023) are vertically aligned.

Force-torque sensors. Various types of force-torque sensors can be used. Preferred is to rely on a 6-axis force-torque sensor, such as the Bota Systems SensONE 6-axis force-torque sensor, to measure reaction forces acting on the tools.

End effectors. The end effector designs proposed herein integrate several tools. To start with, the end effector includes the male part (i.e., the plug 106) of the charging cable, which is meant to be plugged into charge ports of vehicles. Second, it further integrates an actuator 114, 115 to handle the charge port door. Both tools are rigidly linked to the wrench of the force-torque sensor 103, such that it is possible to measure reaction forces acting on the tool centre points (TCP). The combination of both tools in one end effector eliminates the need for tool switching programs and simplifies the overall plugging process. Note, the depth camera 102 is directly mounted to the housing of the force-torque sensor, as an eye-in-hand camera. This allows to compensate for absolute position errors of the manipulator, which can typically be on the order of millimetres. All the required parts of the body 108 can be 3D printed using fused deposition modelling (FDM) and polylactic acid (PLA) filaments. It is desired to firmly attach the charging cable 12 to the force-torque sensor 103, as any slippage or deformations could lead to errors in the tool calibration, which would decrease the success rate of the plugging algorithm. The inlet of the charging cable is preferably constrained, mechanically, to ensure a certain angle between the cable 12 and the lower part of the body 108, and accordingly prevent inadvertent interferences between the cable 12 and the robotic arm 40, as assumed in FIGS. 2-5.

Electropermanent magnets. Various types of electropermanent magnet parts can be used, such as the Magnetic Tool Changer NTC-E10 flanges from Unchained Robotics.

System. FIG. 7 shows a schematic overview of a preferred system architecture. One option is to rely on a single (master) computer 2, e.g., a standard desktop computer 2 using Ubuntu 20.04 as operating system and a standard kernel (e.g., LINUX 5.4). The robot arm controller 70 and the force-torque sensor 103 are connected to the master computer 2 using Ethernet (via the network switch 3). Other communications (e.g., to/from the camera 102 and to the LED control unit 65) can be ensured via a universal service bus (USB) hub 4, as depicted in FIG. 7. Alternatively, two computers may be used, one running Ubuntu 20.04 and an RT-kernel (e.g., LINUX 5.4 Preemt-RT kernel patch) to run the real-time critical force controllers and trajectory-following controllers, the other running Ubuntu 20.04 and a standard kernel (e.g., LINUX 5.4) to run other algorithms (e.g., vision algorithms, state machine algorithms, etc.).

All required software can for instance be written in C++ 14 and python 3. An adequate robot operating system (e.g., noetic) is used as middleware for communication between the individual software modules and devices. More generally, the methods described herein shall typically be in the form of executable program, script, or any suitable form of executable instructions. Computerized devices can suitably be configured for implementing embodiments of the present invention as described herein. In that respect, it can be appreciated that the methods described herein are at least partly non-interactive, i.e., automated. In general, automated parts of such methods can be implemented in software, hardware, or a combination thereof.

### 2.2 Preferred Flow

FIG. 8 shows a preferred flow, which assumes the use of controllably attachable end effectors 10, 10b. At step S10, the robotic arm connects to an end effector 10, with a view to electrically charging a vehicle. To that aim, the system 1 determines S20 whether the charge port door is closed, using computer vision. If so (S30, Yes), another computer vision algorithm is run to determine S40 the door pose. Next, step S50, the robotic arm 40 actuates the end effector 10 for the actuator 114, 115 to establish S50 contact and open S60 the charge port door. Else (S30, No), the algorithm directly goes to step S80, to determine S80 the charge port pose, e.g., using again a computer vision algorithm. Once this is done, the robotic arm actuates the end effector for the plug 106 to establish S90 contact and connect S100 the plug to the charge port and charge the vehicle. Use is made of the force feedback provided by the force-torque sensor 103.

Having plugged the connector 106, 108, the robotic arm may possibly disconnect S110 from the end effector, with a view to start another sequence, using another end effector. Thus, the robotic arm may fetch S115 another end effector, in order to charge a further vehicle (according to steps S10 to S110) or disconnect this other end effector from another vehicle, assuming the latter is now fully charged, in accordance with steps S118 to S150 below.

At step S118, the robotic arm reconnects to an end effector that is already plugged in the other vehicle and then disconnects S120 this end effector from its charge port, prior to closing S130 the corresponding charge port door (by adequately moving the actuator 114, 115). Once the charge port door is closed S140, the robotic arm brings the end effector back to the workstation and disconnects S150 from this end effector. Another sequence may then be started, and so on.

### 2.3 Computer Vision and Force-Feedback

Various computer vision may be used to adequately actuate the end effector, open the charge port door, and plug the electrical connector to a charge port. Preferred is to use a combination of vision and force feedback to solve these issues. Indeed, pure vision-based cable plugging is difficult to deploy in practice because environmental image noise may impair the estimation accuracy. Instead, active compliance can be used to compensate for estimation errors, thereby loosening requirements on vision estimation accuracy. That is, a cable plugging pipeline can be used to approximately estimate the plug pose based on vision data and plug the charging cable with force and compliance control. Similarly, a combination of vision and force feedback can be used to open the charge port door.

However, when the door is closed, the car body geometry in the vicinity of the charge port door is almost planar. This means that there are no distinctive features to estimate in-plane translations. Therefore, point cloud-based methods can be unsuitable. Instead, a combination of 2D images and depth information can advantageously be used to locate the door in the query image, hence the benefit of using a depth camera.

While the present invention has been described with reference to a limited number of embodiments, variants, and the accompanying drawings, it will be understood by those skilled in the art that various changes may be made, and equivalents may be substituted without departing from the scope of the present invention. In particular, a feature (device-like or method-like) recited in a given embodiment, variant or shown in a drawing may be combined with or replace another feature in another embodiment, variant, or drawing, without departing from the scope of the present invention. Various combinations of the features described in respect of any of the above embodiments or variants may accordingly be contemplated, that remain within the scope of the appended claims. In addition, many minor modifications may be made to adapt a particular situation or material to the teachings of the present invention without departing from its scope. Therefore, it is intended that the present invention is not limited to the particular embodiments disclosed, but that the present invention will include all embodiments falling within the scope of the appended claims. In addition, many other variants than explicitly touched above can be contemplated. For example, other types of robotic manipulators, cameras, electropermanent magnets, and force-torque sensors, may be contemplated. In addition, the end effectors shown in FIGS. 2-5 may be designed so as to show different visual qualities.

### REFERENCE LIST

1 Automated vehicle charging robot
10, 10a, 10b End effector
10, 40 Functionalized robotic arm
100 Connecting module
101 Rear panel/end section of electrical connector body
101-105 Connecting submodules
101, 106, 108 Electrical connector
102 Depth camera (1021: RGB sensor; 1022: first IR sensor; 1023: IR beamer; 1024: second IR sensor)
103 Force-torque sensor
104, 105 Electropermanent magnet parts
106 Electrical connector plug
108 Electrical connector body
114 Actuator protruding part
114, 115 Charge port door actuator
115 Actuator pressure member
12 Charging cable
2 Computerized system/master computer
205 Vehicle body
210 Vehicle charge port door
220 Vehicle charge port
3 Network switch
40 Robotic arm
50 Charging station
60 Light source
70 Robotic arm controller
80 Workstation
Dₐ Average actuator direction
D_{c} Axial direction
De Extension direction of electrical connector
Dₚ Extension direction projection in reference plane P
Dₜ Camera rotation axis
P Reference plane
α Angle between extension direction Dₑ of body 108 and axial direction D_{c}
β Angle between connector body 108 and reference plane P
γ Camera offset angle

1. An end effector for an automated vehicle charging robot, the end effector comprising:
a connecting module, which is delimited by a reference plane and is designed to enable a connection of the end effector to a robotic arm of the charging robot on a first side of the reference plane;
an electrical connector including a body and a plug, the plug designed to connect to a charge port and arranged at an end of the body, wherein the body extends from the connecting module to the plug on a second side of the reference plane, the second side opposite to said first side, along an extension direction that is transverse to the reference plane; and
an actuator that protrudes from said body, transversely to said extension direction, the actuator designed to actuate a door of the vehicle charge port.

2. The end effector according to claim 1, wherein
the extension direction of the body is inclined with respect to an axial direction that is perpendicular to the reference plane.

3. The end effector according to claim 2, wherein
the extension direction of the body forms an angle with the axial direction that is between 25 degrees and 45 degrees.

4. The end effector according to claim 2, wherein
the connecting module is designed to allow the end effector to axially connect to the robotic arm, along said axial direction.

5. The end effector according to claim 1, wherein
an average direction of the actuator is perpendicular to the extension direction of the body.

6. The end effector according to claim 1, wherein
the actuator is recessed with respect to the plug along said extension direction, so as to be closer to the connecting module than to the plug.

7. The end effector according to claim 1, wherein
the connecting module includes several submodules designed to cooperate with each other to enable said connection.

8. The end effector according to claim 7, wherein
the submodules are designed to enable said connection as a controllably detachable connection.

9. (canceled)

10. The end effector according to claim 7, wherein
the submodules include a force-torque sensor, which is axially connectable to another one of the submodules.

11. The end effector according to claim 10, wherein
the force-torque sensor is designed to be fixedly mounted, axially, to the robotic arm, to allow the end effector to axially connect to the robotic arm via the force-torque sensor.

12. The end effector according to claim 11, wherein
the submodules further include two magnetic parts forming an electropermanent magnet, wherein one of the two magnetic parts is fixedly mounted to an end section of the body of the electrical connector, whereas the other one of the magnetic parts is fixedly mounted, axially, to the force-torque sensor, to allow the end effector to be controllably attached to the robotic arm.

13. The end effector according to claim 7, wherein
the end effector further includes a camera that is fixed to one of the submodules that is the farthest from the plug.

14. The end effector according to claim 13, wherein
the camera is arranged on one side of a plane containing the extension direction and a projection of the latter in the reference plane, in such a manner that neither the actuator nor the body of the electrical connector is in a field of view of the camera.

15. The end effector according to claim 14, wherein
the camera has at least one sensor, which includes a lens, the optical axis of which is transverse to the reference plane,
the optical axis is rotated around a rotation axis that is parallel to the projection of the extension direction, by an offset angle, and
the offset angle is between 10 degrees and 30 degrees, so that neither the actuator nor the body of the electrical connector is in the field of view of the camera.

16. (canceled)

17. The end effector according to claim 15, wherein
the camera is a depth camera that includes two or more sensors, which are arranged along an axis that is parallel to the rotation axis.

18. The end effector according to claim 1, wherein
the actuator includes a protruding part and a pressure member, the latter designed to come in contact with the charge port door, and
the protruding part extends from the body to the pressure member.

19. A functionalized robotic arm for an automated vehicle charging robot, wherein the functionalized robotic arm includes:
a robotic arm, and
an end effector, which includes
a connecting module, which is delimited by a reference plane and is designed to enable a connection of the end effector to a robotic arm of the charging robot on a first side of the reference plane;
an electrical connector including a body and a plug, the plug designed to connect to a charge port and arranged at an end of the body, wherein the body extends from the connecting module to the plug on a second side of the reference plane, the second side opposite to said first side, along an extension direction that is transverse to the reference plane; and
an actuator that protrudes from said body, transversely to said extension direction, the actuator designed to actuate a door of the vehicle charge port, the connecting module of the end effector being connected or connectable to the robotic arm.

20. An automated vehicle charging system, including
a functionalized robotic arm, which comprises:
a robotic arm, and
an end effector, which includes
a connecting module, which is delimited by a reference plane and is designed to enable a connection of the end effector to a robotic arm of the charging robot on a first side of the reference plane;
an electrical connector including a body and a plug, the plug designed to connect to a charge port and arranged at an end of the body, wherein the body extends from the connecting module to the plug on a second side of the reference plane, the second side opposite to said first side, along an extension direction that is transverse to the reference plane; and
an actuator that protrudes from said body, transversely to said extension direction, the actuator designed to actuate a door of the vehicle charge port, the connecting module of the end effector being connected or connectable to the robotic arm, and
a computerized system, which is operatively connected to the functionalized robotic arm and configured to instruct the robotic arm to actuate the end effector, so as to open a charge port door of a vehicle via the actuator of the end effector and connect the plug of the electrical connector of the end effector into a charge port of the vehicle.

21. The automated vehicle charging system according to claim 20, wherein
the automated vehicle charging system further includes a charging station to which several end effectors are electrically connected, each of the end effectors being controllably attachable to and detachable from the robotic arm.

22. A method of electrically charging an electrical vehicle using a functionalized robotic arm,
wherein
the functionalized robotic arm includes a robotic arm and an end effector, the end effector including:
a connecting module, which is delimited by a reference plane and is designed to enable a connection of the end effector to a robotic arm of the charging robot on a first side of the reference plane;
an electrical connector including a body and a plug, the plug designed to connect to a charge port and arranged at an end of the body, wherein the body extends from the connecting module to the plug on a second side of the reference plane, the second side opposite to said first side, along an extension direction that is transverse to the reference plane; and
an actuator that protrudes from said body, transversely to said extension direction, the actuator designed to actuate a door of the vehicle charge port, the connecting module of the end effector being connected or connectable to the robotic arm,
wherein the method comprises:
actuating the end effector via the robotic arm according to a first actuation sequence to open a charge port door of a charge port of a vehicle via the actuator of the end effector, and
actuating the end effector via the robotic arm according to a second actuation sequence to connect the plug of the electrical connector of the end effector to the charge port.

23-25. (canceled)
